(19) United States
(12) Patent Application Publication
(10) Pub. No.: US 2013/0283577 A1
(43) Pub. Date: Oct. 31, 2013

(54) HOOK FOR CLAMPING TWO COVERS

(71) Applicant: Xiao-Hui ZHOU, Shenzhen City (CN)

(72) Inventor: Xiao-Hui ZHOU, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/531,405

(22) Filed: Jun. 22, 2012

(30) Foreign Application Priority Data
Apr. 28, 2012 (CN) 201210130148.8

(51) Int. Cl. F16B 45/00

(52) U.S. Cl. 24/592.11

(57) ABSTRACT

A hook includes two parts. A first hook element is fixed on a first cover. The first hook element includes two supporting panels extending from a surface of the first cover and spaced from each other, a first flat panel connecting tops of the two supporting panels, and a receiving space formed by the first cover, the two supporting panels, and the first flat panel. A second hook element is fixed on a second cover. The second hook element includes a supporting member extending from a surface of the second cover, a second flat panel extended from a distal end of the supporting member and parallel to the surface of the second cover, and a groove formed between the supporting member and the second flat panel. The first flat panel is slid into and engaged with the groove, and clamped between the second flat panel and the supporting member.

### BACKGROUND

1. Technical Field

The disclosure relates to hooks and, more particularly, to a hook which is utilized for clamping two covers.

2. Description of Related Art

Hollow pillars are often used to connect two covers of a device. The two covers are engaged by twisting a screw into each hollow pillar. However, when twisting a screw into each hollow pillar, the hollow pillar could be easily broken and the covers are thus damaged.

Therefore, what is needed is a new hook to overcome the described shortcoming.

### BRIEF DESCRIPTION OF THE DRAWINGS

FIG. 1 is an exploded, perspective view of a hook positioned on two covers, in accordance with an exemplary embodiment.

FIG. 2 is an enlarged view of a first hook element of the hook of FIG. 1, positioned on a first cover.

FIG. 3 is an enlarged view of a second hook element of the hook of FIG. 1, positioned on a second cover.

FIG. 4 is a sectional view of the hook of FIG. 1, clamping the two covers.

### DETAILED DESCRIPTION

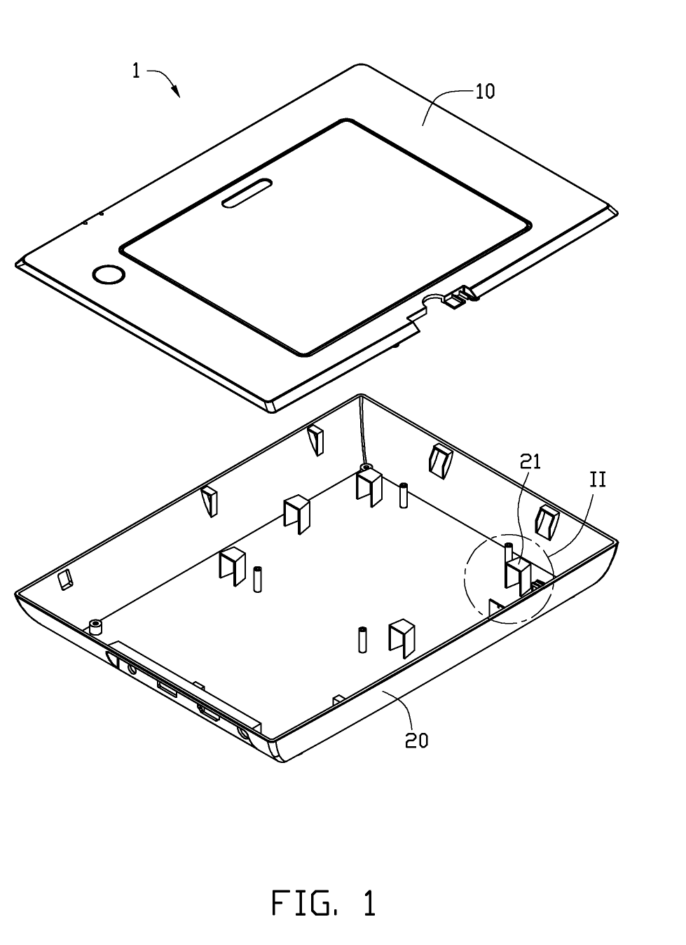

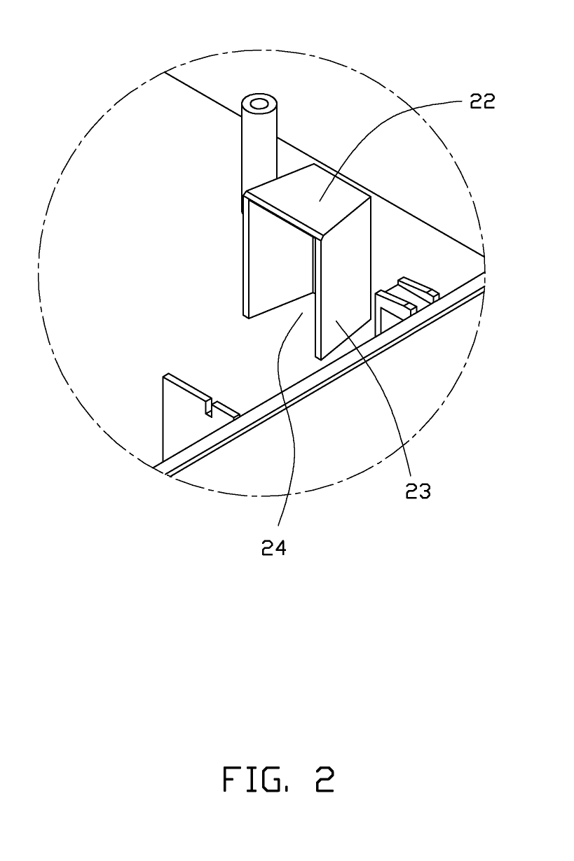

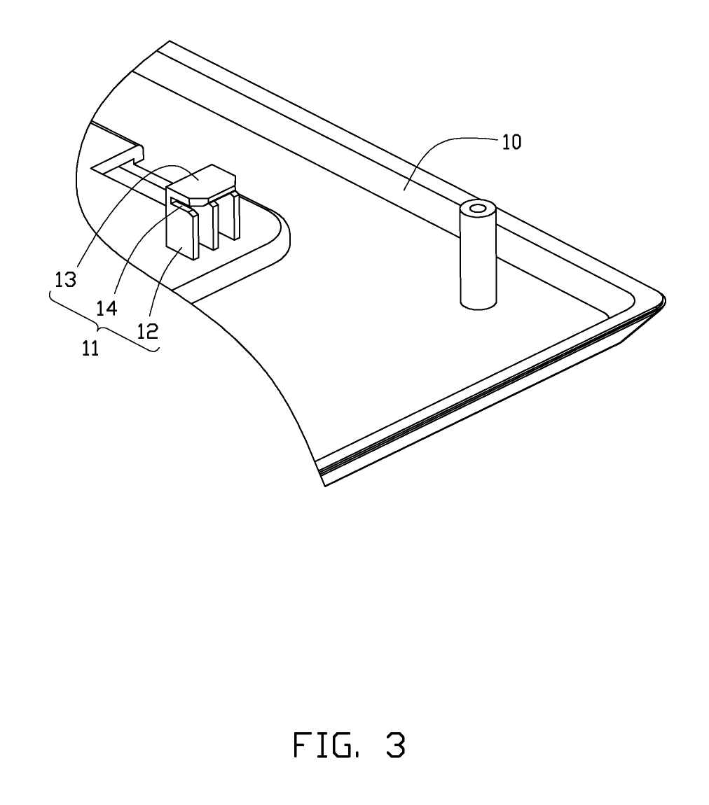

Referring to FIGS. 1-3, a hook 2 is applied on a device 1 and utilized for clamping two covers of the device 1. The two covers include a first cover 20 and a second cover 10. The hook 2 includes a first hook element 21 and a second hook element 11.

The first hook element 21 is fixed on the first cover 20. The first hook element 21 includes two supporting panels 23, a first flat panel 22, and a receiving space 24. The two supporting panels 23 extends from a surface of the first cover 20 and are spaced from each other. The first flat panel 22 connects tops of the two supporting panels 23. The receiving space 24 is formed by the first cover 20, the two supporting panels 23, and the first flat panel 22.

The second hook element 11 is fixed on the second cover 10. The second hook element 11 includes a supporting member 12, a second flat panel 13, and a groove 14. The supporting member 12 extends from a surface of the second cover 10. The second flat panel 13 is extended from a distal end of the supporting member 12 and parallel to the surface of the second cover 10. The groove 14 is formed between the supporting member 12 and the second flat panel 13. In the embodiment, the supporting member 12 is composed of at least two rectangular panels which are parallel each other. In another embodiment, the supporting member 12 is a rectangular block. A thickness of the first flat panel 22 of the first hook element 21 is equal to a width of the groove 14 of the second hook element 11.

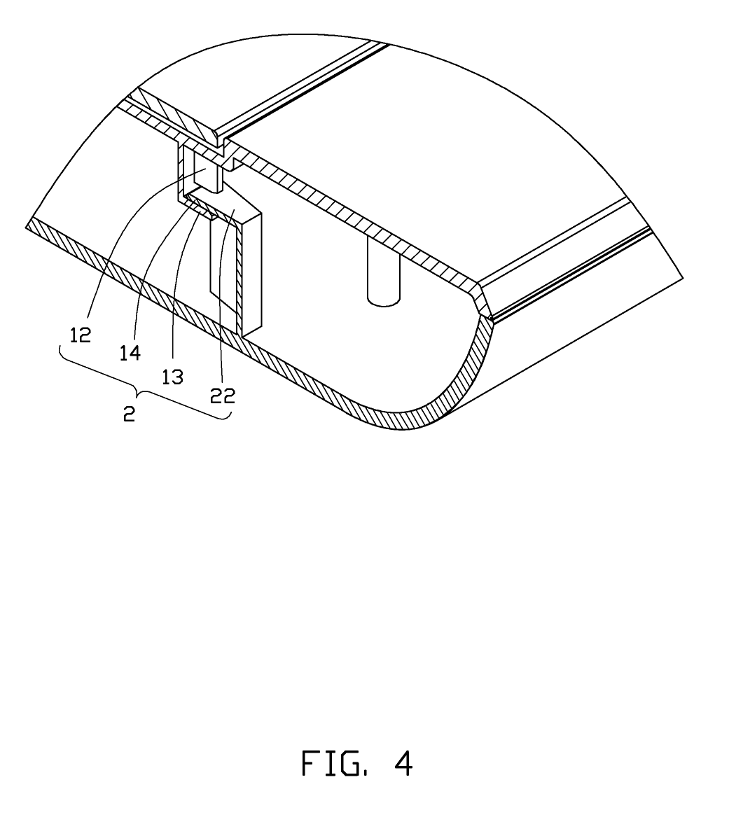

Referring to FIG. 4, the first cover 20 is engaged with the second cover 10 via the hook 2. When clamping the first and the second covers 20, 10 together, the first cover 20 or the second cover 10 moves from one side, the first flat panel 22 of the first hook element 21 is slid into and engaged with the groove 14 of the second hook element 11, the second flat panel 13 is accommodated in the receiving space 24, and the first flat panel 22 is clamped between the second flat panel 13 and the supporting member 12 of the second hook element 11. Therefore, the first cover 20 and the second cover 10 are engaged each other via the hook 2.

In the embodiment, the number of the hook 2 is one. In another embodiment, the first cover 20 and the second cover 10 of the device 1 are engaged each other via a number of hooks.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A hook for clamping a first and a second covers together, the hook comprising:
a first hook element fixed on the first cover, the first hook element comprising:
two supporting panels extending from a surface of the first cover and spaced from each other; and
a first flat panel connecting tops of the two supporting panels, wherein a receiving space is formed between the first cover, the two supporting panels, and the first flat panel, and
a second hook element fixed on the second cover, the second hook element comprising:
a supporting member extending from a surface of the second cover;
a second flat panel extended from a distal end of the supporting member and parallel to the surface of the second cover; and
a groove formed between the supporting member and the second flat panel;
wherein when clamping the first and the second covers together, the first flat panel of the first hook element is slid into and engaged with the groove of the second hook element, and clamped between the second flat panel and the supporting member of the second hook element.

2. The hook as recited in claim 1, wherein the supporting member is a rectangular block.

3. The hook as recited in claim 1, wherein the supporting member is composed of at least two rectangular panels which are parallel each other.

4. The hook as recited in claim 1, wherein a thickness of the first flat panel of the first hook element is equal to a width of the groove of the second hook element.
